(19) United States
(12) Patent Application Publication
(10) Pub. No.: US 2018/0283993 A1
(43) Pub. Date: Oct. 4, 2018

(54) DESORBER AND TRAP FOR TRACE DETECTION SYSTEM

(71) Applicant: Morpho Detection, LLC, Newark, CA (US)

(72) Inventors: Bradley Douglas Shaw, Plaistow, NH (US); Dung Lu, Maiden, MA (US); Khai Bui, Milton, MA (US)

(73) Assignee: Morpho Detection, LLC, Newark, CA (US)

(21) Appl. No.: 15/473,270

(22) Filed: Mar. 29, 2017

(51) Int. Cl. G01N 1/02; G01N 1/44; G01N 21/59; G01V 8/12

(52) U.S. Cl. CPC G01N 1/02; G01N 1/44; G01N 21/59; G01V 8/12; G01N 2001/022; G01N 2201/068; G01N 2201/062; G01N 2001/028; G01N 2201/061

(57) ABSTRACT

A trap for an analysis device. The trap includes a body configured to be at least partially inserted into an inlet of a desorber assembly of the analysis device. The desorber is configured to selectively operate in a plurality of analysis modes. The body includes a first surface and a feature. The first surface is configured to receive, on a first region thereof, a sample of a substance of interest for analysis by the analysis device. The feature is located in a second region of the first surface and detectable by the desorber upon insertion into the inlet thereof. The feature is associated with one of the plurality of analysis modes.

### BACKGROUND

The field of the disclosure relates generally to trace detection systems and, more particularly, to a trap for insertion into a desorber assembly of a trace detection system.

Various technologies exist for detection of substances of interest, such as explosives and illicit drugs. Some trace detection technologies use spectrometric analysis of ions formed by ionization of vapors of substances of interest. Spectrometric analysis includes ion mobility spectrometry and mass spectrometry, for example, both of which are common in trace detection.

Such trace detection systems analyze a sample of a substance introduced to the system on a trap. The trap is swabbed on a surface on which a trace of a substance of interest may be present, such as, for example, a surface of luggage, a handbag, or a person's body, e.g., a person's hands. The trap is then inserted into a desorber of an analysis device where the sample is rapidly heated to vaporize the substance. Vaporization of the substance may be achieved by one or more of flash heating, laser desorption, radio frequency heating, and microwave heating. The vapor separates from the trap and moves through the trace detection system where it interacts with one or more dopants, charged ions, or undergoes other processes before it is analyzed.

The trap itself may have various forms and compositions for different systems and analysis. For example, certain traps are intended for desorption in a certain band of temperatures. Such traps may be referred to simply as high-temperature traps or low-temperature traps, which operate, for example, at or above 300 degrees C. and below 300 degrees C., respectively. Likewise, some traps are intended to enable more sensitive detection of certain chemicals, which may include, for example, temperature limitations. Use of such specialized traps enhances detection capabilities of the trace detection system.

### BRIEF DESCRIPTION

In one aspect, a trap for an analysis device is provided. The trap includes a body configured to be at least partially inserted into an inlet of a desorber assembly of the analysis device. The desorber is configured to selectively operate in a plurality of analysis modes. The body includes a first surface and a feature. The first surface is configured to receive, on a first region thereof, a sample of a substance of interest for analysis by the analysis device. The feature is located in a second region of the first surface and detectable by the desorber upon insertion into the inlet thereof. The feature is associated with one of the plurality of analysis modes.

In another aspect, a desorber assembly for an analysis device is provided. The desorber includes an inlet, a sensor subsystem, and a heating subsystem. The inlet is configured to receive a trap having, on a first region thereof, a sample of a substance of interest for analysis by the analysis device, the analysis selected from a plurality of analysis modes, and a detectable feature located in a second region of the trap, wherein the detectable feature is associated with one of the analysis modes. The sensor subsystem is configured to detect the detectable feature upon insertion of the trap into the inlet. The heating subsystem is configured to heat the sample according to the one of the plurality of analysis modes upon detecting the detectable feature.

In yet another aspect, a method of operating an analysis device is provided. The method includes receiving, at a desorber of the analysis device, a trap on which a sample of a substance of interest for analysis is located. The method includes detecting, by a sensor subsystem, a detectable feature of the trap upon insertion thereof into the desorber to identify a type of the trap. The method includes selecting, by a processor, an analysis mode from among a plurality of analysis modes based on the type of the trap. The method includes generating, by the desorber, a vapor from the sample according to the analysis mode. The method includes conducting analysis on the vapor according to the analysis mode.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective diagram of an exemplary desorber assembly with a housing;

FIG. 2 is a perspective diagram of the desorber assembly shown in FIG. 1 without the housing;

FIG. 3 is a perspective diagram of an exemplary trap;

FIG. 4 is a perspective diagram of another exemplary trap;

FIGS. 5A through 5D are perspective diagrams of a portion of the desorber assembly shown in FIG. 2 illustrating four detectable conditions of trap insertion;

FIG. 6 is a block diagram of an exemplary trace detection system embodying the desorber assembly and traps shown in FIGS. 1-4; and

FIG. 7 is a flow diagram of an exemplary method of operating the trace detection system shown in FIG. 6.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

At least some known traps for trace detection systems are intended for a specialized use in conducting trace detection. For example, certain traps are intended for high-temperature desorption, e.g., at or above 300 degrees C., while others are intended for low-temperature, or standard, desorption, e.g., below 300 degrees C. Such traps, for example, are referred to as high-temperature traps and low-temperature, or standard, traps. Generally, standard traps will decompose and produce noxious fumes or other by-products that may interfere with the analysis performed by the trace detection system when heated above, for example 300 degrees C. High-temperature traps are typically constructed of materials that can withstand such high temperatures, for example, up to 400 degrees C., without producing significant amounts of undesirable gas by-products. Such high-temperature traps are generally limited to non-electrically conductive materials. Some traps, for example, are constructed of woven fiberglass that provides a desirable amount of stiffness and flexibility for insertion into a desorber assembly. Certain embodiments include a protective coating, such as, for example polytetrafluoroethylene (PTFE), which is realtively inert and does not contribute significant amounts of additional vapor when heated. Other types of traps include particular chemicals embedded in the material that aid in trace detection when inserted into the desorber.

It is realized herein it is important to properly identify, upon insertion of a given trap into a desorber assembly, what type of trap the given trap is in terms of form or composition that serves to narrow its intended use for a particular mode of operating the trace detection system. For example, an exemplary trace detection system may operate in multiple different modes, including a high-temperature mode when it detects a high-temperature trap is inserted in the desorber assembly. Likewise, such a trace detection system may operate in a standard mode when it detects a standard trap. In alternative embodiments, the trace detection system may select among two or more operating modes for detecting specific substances of interest based on such identification of the type of trap.

Embodiments of the desorbers and traps described herein enable identification of a type of a given trap upon insertion into the desorber. More specifically, the traps described herein incorporate identifying features that are detectable by the desorbers described herein when such a trap is inserted into such a desorber. In one embodiment, the desorber assembly includes one or more light sources and light sensors that detect the unique interactions of various types of traps with the light when a given trap is inserted into the desorber assembly. The various types of traps incorporate unique combinations of features that interact with the light, including, for example, hole patterns that vary in dimensions, location, and quantity. In certain embodiments, various types of traps may incorporate unique combinations of filters or lenses that modify the light emitted from the desorber as the light passes through a given trap. In alternative embodiments, the various types of traps incorporate unique encoding, such as, for example bar codes, or radio frequency identification (RFID). In other alternative embodiments, the various types of traps incorporate unique structural features for engaging a mechanical switch, proximity sensor, or other suitable sensor. Likewise, the desorber assembly may incorporate such appropriate mechanical switch or sensor for properly detecting the various combinations of features incorporated into the various traps for the purpose of identifying the type of trap inserted.

Trace detection systems that embody the desorbers and traps described herein may further include a control system, processor, or other computing device for receiving and interpreting the identification of the type of trap inserted into the desorber to enable selection of a particular operating mode of the trace detection system itself, such as, for example, selection of a high-temperature mode versus a standard mode.

Generally, substances of interest are any substance that may be received on the trap. Among such substances are many that are harmless and common. Substances of interest also include many that are the target of analysis, which is to screen the substance of interest for traces of one or more of an explosive, an energetic material, a taggant, a narcotic, a pharmaceutical product, a toxin, a chemical warfare agent, a biological warfare agent, a pollutant, a pesticide, a toxic industrial chemical, a toxic industrial material, a homemade explosive, a pharmaceutical trace contaminant, a biomarker for medical applications, a chemical marker for medical applications, a biomarker for clinical hygienic applications, a chemical marker for clinical hygienic applications, a precursor thereof, a byproduct thereof, a metabolite thereof, and combinations thereof.

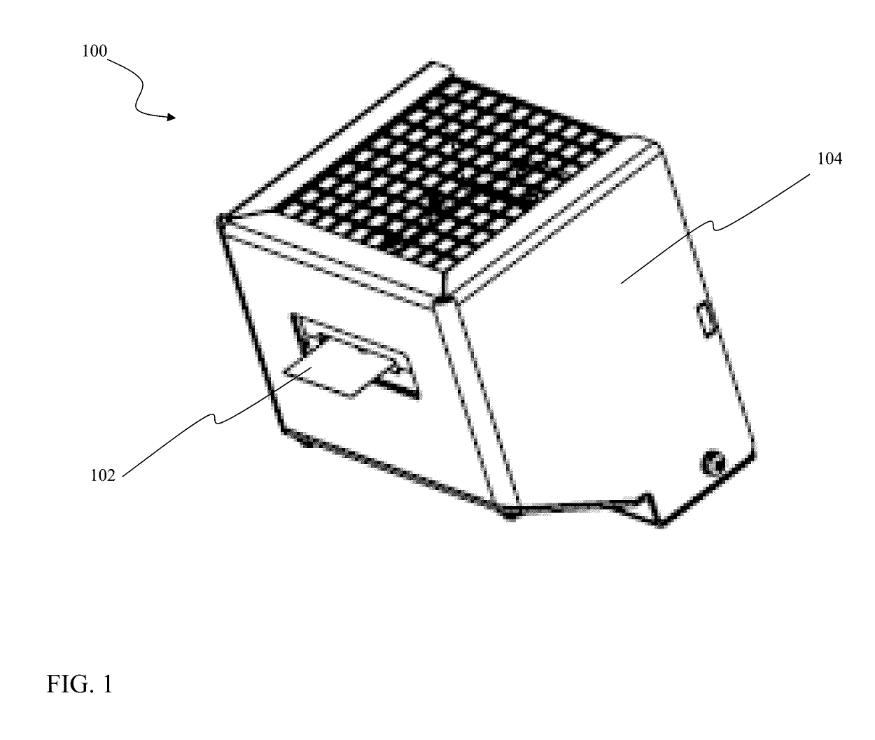

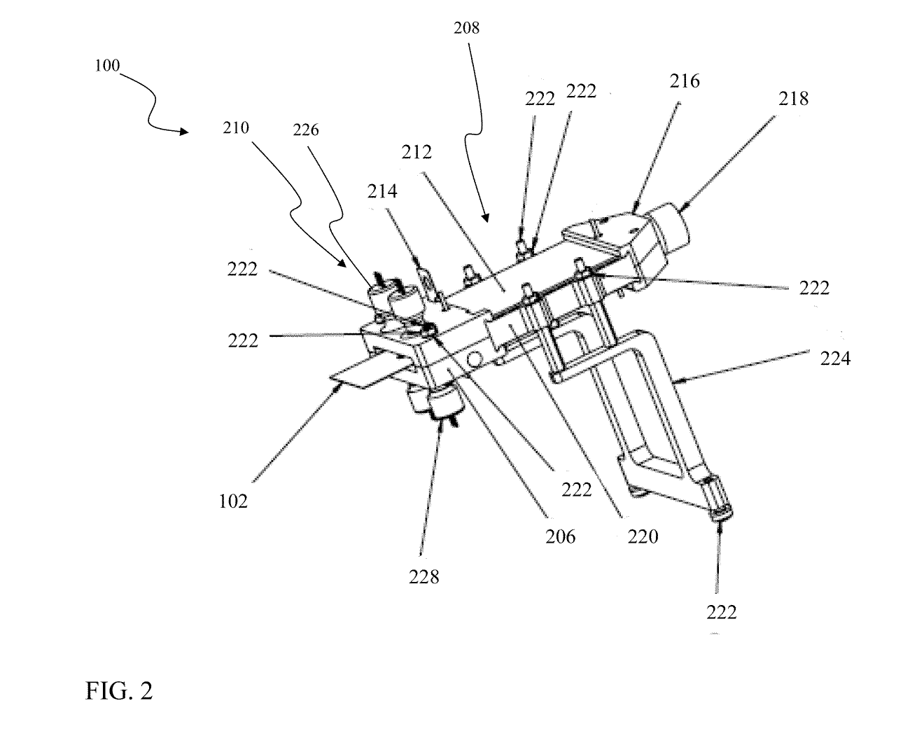

FIG. 1 is a perspective diagram of an exemplary desorber assembly 100 for use in a trace detection system. Desorber assembly 100 is configured to receive a trap 102 on which a sample of a substance of interest to be analyzed is located. Desorber assembly 100 includes a housing 104. FIG. 2 is a perspective diagram of desorber assembly 100, shown in FIG. 1, without housing 104. Desorber assembly 100 includes an inlet 206, a heating subsystem 208, and a sensor subsystem 210. Inlet 206 is configured to receive trap 102. Heating subsystem 208 includes an enclosure 212 into which trap 102 extends when inserted into inlet 206. Heating subsystem 208 further includes a heating element 214 configured to heat an interior of enclosure 212, trap 102, and the sample contained thereon to generate a vapor from the sample that can be analyzed using an analysis mode selected from among two or more analysis modes. For example, in certain embodiments, analysis is conducted according to a first analysis mode preferred for desorption at high temperatures, e.g., at or above 300 degrees C., or a second analysis mode preferred for desorption at low temperatures, e.g., below 300 degrees C.

The vapor generated within enclosure 212 exits through a funnel 216 and nozzle 218 located opposite inlet 206 with respect to heating subsystem 208. After exiting through nozzle 218, the vapor may undergo various processes and interactions before analysis is conducted according to the selected analysis mode. Such analysis may include, for example, ion mobility spectrometry.

Inlet 206, enclosure 212, and funnel 216 are coupled in series and fixed as an assembly by a holder assembly 220 and various fasteners 222. The assembly of inlet 206, enclosure 212, and funnel 216 is supported within desorber assembly 100 by a standoff 224 and further fasteners 222.

Sensor subsystem 210 is configured to detect a detectable feature of trap 102 upon its insertion into inlet 206. In the embodiment shown in FIG. 2, sensor subsystem 210 includes one or more light source 226 and one or more light sensor 228. Light source 226 may include a light amplification by stimulated emission of radiation (LASER), a light emitting diode (LED), or other suitable light source for generating a transmission of light. Likewise, light sensor 228 may include a photodiode, a photoresistor, a phototransistor, or other suitable device for detecting the transmission of light from light source 226 as it interacts with the detectable feature of trap 102. In the embodiment shown in FIG. 2, light source 226 is configured to emit a transmission of light from one side of inlet 206, onto or through trap 102, and to an opposite side of inlet 206 where light sensor 228 is mounted.

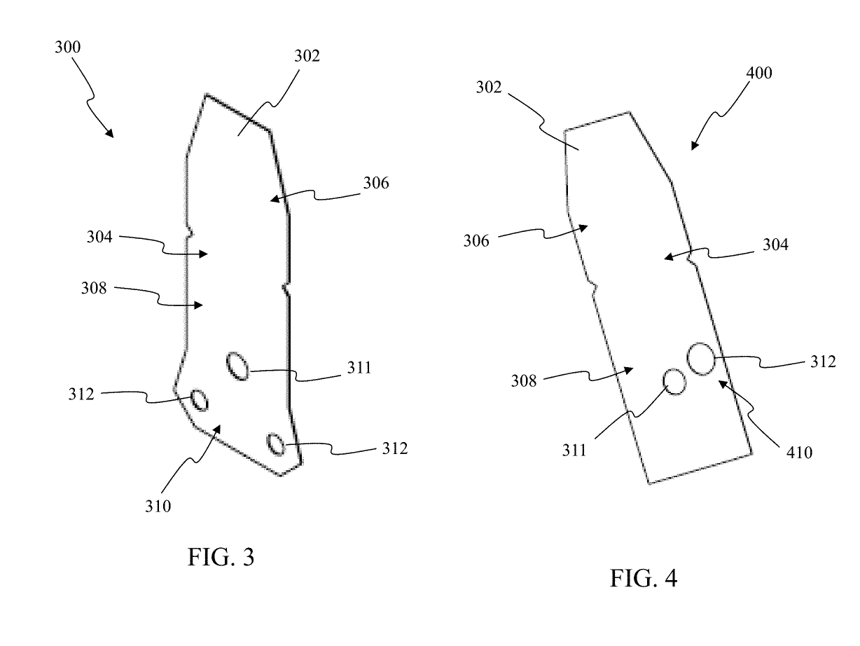

FIGS. 3 and 4 are perspective diagrams of exemplary traps 300 and 400, respectively, for use in desorber assembly 100, shown in FIGS. 1 and 2. Traps 300 and 400 include a body 302 configured to be inserted, at least partially, into inlet 206 of desorber assembly 100, shown in FIGS. 1 and 2. Body 302 is generally formed of a material that provides sufficient flexibility and rigidity for insertion into desorber assembly 100, and that can withstand temperatures necessary for desorption of a sample of a substance of interest captured on the trap for analysis. For example, in one embodiment, body 302 is composed of a fiberglass mesh coated in PTFE, and can withstand temperatures up to 300 degrees C.

Body 302 includes a first surface 304 and a second surface (not shown). Body 302 of traps 300 and 400 is substantially flat. In alternative embodiments, body 302 varies in thickness and corresponds to the dimensions of inlet 206 of desorber assembly 100 to enable insertion. Surface 304 of traps 300 and 400 is divided generally into a first region 306 and a second region 308. First region 306 is configured to receive the sample of the substance of interest for analysis, and is generally characterized as the end first-inserted into inlet 206 of desorber assembly 100. Second region 308 is located opposite first region 306 and includes a detectable feature 310 on trap 300 and a detectable feature 410 on trap 400. Detectable features 310 and 410 are detectable by desorber assembly 100 upon insertion of trap 300 or 400 into inlet 206 of desorber assembly 100. More specifically, upon insertion of trap 300 or 400 into inlet 206, detectable features 310 and 410 are detected by sensor subsystem 210.

Traps 300 and 400 each include a mounting hole 311 configured to engage a wand (not shown) or other device utilized in the process of swabbing or otherwise receiving the sample. For example, such a wand may include a post configured to protrude through mounting hole 311 to secure traps 300 and 400 to the wand. Accordingly, mounting hole 311 is distinct from detectable features 310 and 410 of traps 300 and 400.

Detectable features 310 and 410 are any characteristic of trap 300 or 400 that is detectable by sensor subsystem 210 of desorber assembly 100. Such detectable features 310 and 410 may include, for example, one or more holes, i.e., openings or voids, in body 302 that enable a transmission of light to pass through and be detected by sensor subsystem 210. Mounting hole 311 is excluded from detectable features 310 and 410 because it is not detectable by sensor subsystem 210 and, further, is not associated with any operating mode of the desorber or analysis device. Detectable features 310 and 410 may enable the transmission of light to pass through unaltered, or may modify the transmission of light in a detectable manner. For example, detectable features 310 and 410 may include a combination of filters or lenses to modify the light emitted by sensor subsystem 210. Likewise, detectable features 310 and 410 block at least some of the transmission of light from passing through traps 300 and 400, and further prevent detection of at least some of the transmission of light by sensor subsystem 210. Traps 300 and 400 include a plurality of voids 312, or openings, that vary in location, quantity, and dimension, thereby forming respective hole patterns that are detectable by sensor subsystem 210, unlike mounting hole 311 or other voids intended for other purposes. Detectable feature 310 of trap 300, shown in FIG. 3, identifies trap 300 as a particular type of trap intended for use with a corresponding analysis mode. As such, detectable feature 310 and trap 300 are associated with the corresponding analysis mode. Likewise, detectable feature 410 of trap 400, shown in FIG. 4, identifies trap 400 as another type of trap intended for use with a corresponding analysis mode, thereby associating detectable feature 410 and trap 400 with the corresponding analysis mode. Detectable variations in detectable features 310 and 410, such as, for example, in dimension, shape, location, or quantity, enable further association of additional analysis modes to the trap on which such feature is placed.

Voids 312, in the embodiments of FIGS. 3 and 4, are circular in shape. Voids 312, in alternative embodiments, may vary in shape. Further, in alternative embodiments, detectable feature 310 may include encoding, such as, for example, a bar code or an RFID device. In yet other embodiments, detectable feature 310 may include elements configured to interact, or engage, mechanical switches or proximity sensors of desorber assembly 100.

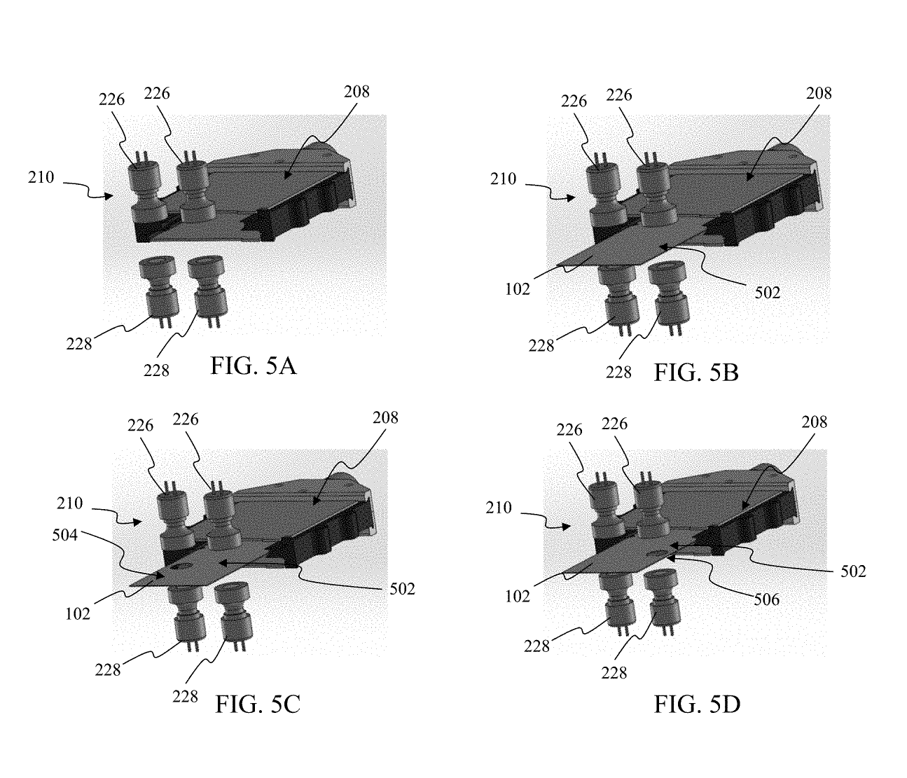

FIG. 5A through 5D are perspective diagrams of a portion of desorber assembly 100 shown in FIG. 2 illustrating four detectable conditions of trap insertion. More specifically, FIG. 5A through 5D show desorber assembly 100, including heating subsystem 208 and sensor subsystem 210, and without inlet 206 (for clarity). FIG. 5A illustrates desorber assembly 100 without trap 102 inserted, and FIGS. 5B, 5C, and 5D illustrate trap 102 inserted and having three different detectable features. More specifically, trap 102 is shown having, or lacking, hole patterns 504, and 506 that enable certain transmissions of light from light sources 226 to light sensors 228, and block certain other transmissions of light from light sources 226, thereby preventing detection by light sensors 228.

FIG. 5A illustrates desorber assembly 100 without trap 102 inserted. Light sources 226 each generate a transmission of light that is unobstructed by any trap that may be inserted with respect to light sensors 228. Each of light sensors 228 detects a respective transmission of light, which can be interpreted, by a processor (not shown) to detect that no trap is inserted.

FIG. 5B illustrates desorber assembly 100 with trap 102 inserted. In the embodiment of FIG. 5B, trap 102 lacks a detectable feature in a region 502 in which an embodiment trap would otherwise include such a detectable feature. Sensor subsystem 210 is configured to detect that trap 102 does not embody such traps introduced herein by detecting the lack of a detectable feature. More specifically, light transmissions from both light sources 226 are blocked by trap 102 and thus prevented from detection by light sensors 228. Accordingly, desorber assembly 100 may be disabled as a result of such detection or, alternatively, may be enabled in a standard, or low-temperature analysis mode.

FIGS. 5C and 5D also illustrate desorber assembly 100 with trap 102 inserted. In the embodiments of FIGS. 5C and 5D, trap 102 includes respective hole patterns 504 and 506 that are detectable by sensor subsystem 210. Hole patterns 504 and 506 are distinct in their respective locations within region 502 of trap 102. More specifically, hole patterns 504 and 506 are bilaterally asymmetric with respect to a centerline of trap 102. Consequently, during operation, certain subsets of light sensors 228 are able to detect the transmissions of light from light sources 226 as they pass through or are blocked by trap 102. The distinct subsets are associated with certain types of traps and certain analysis modes for which those types of traps are intended. In an alternative embodiment, light sensors 228 operate bilaterally symmetric such that trap 102, though asymmetric with hole patterns 504 and 506, is identified as a single type of trap regardless of whether trap 102 is inserted as depicted in FIG. 5C or as depicted in FIG. 5D. In other words, according to FIGS. 5C and 5D, trap 102 may be inserted right-side-up or up-side-down, and light sensors 228 operate to identify trap 102 as one type of trap.

More specifically, in the embodiment of FIG. 5C, hole pattern 504 enables the transmission of light from the left light source 226 to pass through trap 102 and be detected by the left light sensor 228. The transmission of light may be unaltered or modified by hole pattern 504. The transmission of light from the right light source 226 is blocked by trap 102 and thus prevented from detection by the right light sensor 228. The detection of light by the left light sensor 228 and lack of detection of light by the right light sensor 228 identifies trap 102, as shown in FIG. 5C, as a certain type of trap associated with a certain analysis mode. In an alternative embodiment, the transmission of light from the right light source 226 may be detectably modified instead of being entirely blocked by trap 102. Accordingly, the right light sensor 228 detects the modification to the transmission of light.

Conversely, in the embodiment of FIG. 5D, hole pattern 506 enables the transmission of light from the right light source 226 to pass through trap 102 and be detected by the right light sensor 228. The transmission of light may be unaltered or modified by hole pattern 506. The transmission of light from the left light source 226 is blocked by trap 102 and thus prevented from detection by the left light sensor 228. The detection of light by the right light sensor 228 and lack of detection of light by the left light sensor 228 identifies trap 102, as shown in FIG. 5D, as a certain type of trap associated with a certain analysis mode. In an alternative embodiment, the transmission of light from the left light source 226 may be detectably modified instead of being entirely blocked by trap 102. Accordingly, the left light sensor 228 detects the modification to the transmission of light.

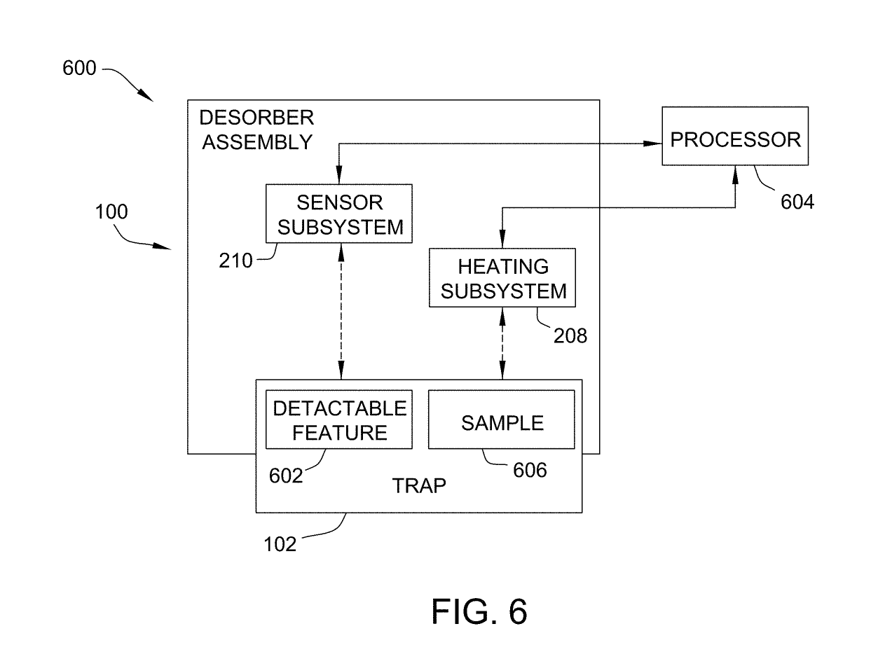

FIG. 6 is a block diagram of an exemplary trace detection system 600 embodying desorber assembly 100 and traps 102, shown in FIGS. 1 and 2. Desorber assembly 100 includes heating subsystem 208 and sensor subsystem 210 respectively configured to interact with trap 102. Trap 102 includes a detectable feature 602 that sensor subsystem 210 is configured to detect upon insertion of trap 102 into desorber assembly 100. Detection of detectable feature 602 by sensor subsystem 210 is relayed to a processor 604 coupled to sensor subsystem 210. Processor 604 is configured to interpret the detection by sensor subsystem 210 to identify the type of trap embodied by trap 102, and further configured to select an analysis mode from among two or more analysis modes.

Processor 604 is further coupled to heating subsystem 208. Processor 604 is configured to control heating subsystem 208 according to the selected analysis mode to generate a vapor from a sample 606 of a substance of interest for analysis. For example, where detectable feature 602 is associated with a high temperature trap, the detection of detectable feature 602 by sensor subsystem 210 is interpreted by processor 604 to identify trap 102 as a high temperature trap. Further, processor 604 selects a high temperature analysis mode, according to which processor 604 control heating subsystem 208. In one embodiment, where the high temperature analysis mode is defined as conducting desorption at a temperature of at least 300 degrees C., processor 604 controls heating subsystem 208 to heat trap 102 and sample 606 to a predetermined temperature, e.g., at or above 300 degrees C., to generate the vapor. Likewise, in another example, where detectable feature 602 is associated with a standard trap, the detection of detectable feature 602 by sensor subsystem 210 is interpreted by processor 604 to identify trap 102 as a standard temperature trap. Further, processor 604 selects a standard analysis mode, according to which processor 604 controls heating subsystem 208.

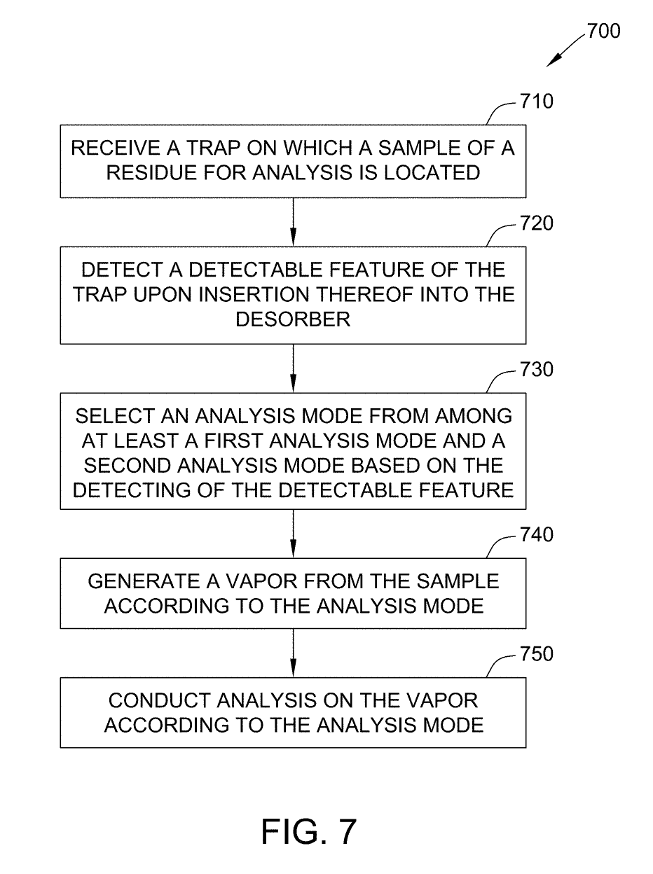

FIG. 7 is a flow diagram of an exemplary method 700 of operating trace detection system 600 shown in FIG. 6, including desorber assembly 100, shown in FIGS. 1, 2, and 5A-5D. Desorber assembly 100 receives 710 trap 102 at inlet 206. Trap 102 contains, in first region 306 of surface 304, sample 606 of a substance of interest for analysis. Further, trap 102 contains detectable feature 602 in second region 308 of surface 304. Detectable feature 602 is associated with an analysis mode, among two or more analysis modes. Sensor subsystem 210 detects 720 detectable feature 602 of trap 102 upon insertion of trap 102 into inlet 206 of desorber assembly 100. Such detection may be embodied, for example, in the generation of a transmission of light from one or more light source 226 and detection of the transmission of light by one or more light sensor 228.

Processor 604 selects 730 the analysis mode associated with detectable feature 602 based on the detection 720 of detectable feature 602 by sensor subsystem 210. Processor 604 controls heating subsystem 208 according to the analysis mode to generate 740 a vapor from sample 606. Further, processor 604 initiates analysis of the vapor, which is conducted 750 according to the analysis mode selected 730 based on detection 720.

An exemplary technical effect of the methods, systems, and apparatus described herein includes at least one of: (a) detecting insertion of a trap into a desorber; (b) detecting a lack of insertion of a trap into a desorber; (c) identifying a trap based on a detectable feature embodied thereon; (d) selecting a mode of analysis based on the type of trap identified; (e) conducting analysis according to the selected mode of analysis; (0 improving analysis sensitivity through use and identification of traps tailored for detection of particular substances of interest; and (g) preventing decomposition of traps by overheating.

Exemplary embodiments of methods, systems, and apparatus for traps and desorbers are not limited to the specific embodiments described herein, but rather, components of systems and/or steps of the methods may be utilized independently and separately from other components and/or steps described herein. For example, the methods may also be used in combination with other non-conventional traps and desorbers, and are not limited to practice with only the systems and methods as described herein. Rather, the exemplary embodiment can be implemented and utilized in connection with many other applications, equipment, and systems that may benefit from increased efficiency, reduced operational cost, and reduced capital expenditure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A trap for an analysis device, comprising:
a body configured to be at least partially inserted into an inlet of a desorber assembly of the analysis device, said desorber configured to selectively operate in a plurality of analysis modes, said body comprising:
a first surface configured to receive, on a first region thereof, a sample of a substance of interest for analysis by the analysis device; and
a feature located in a second region of said first surface and detectable by the desorber upon insertion into the inlet thereof, said feature associated with one of the plurality of analysis modes, wherein the analysis mode is selected from among the plurality of analysis modes based on an identification of the feature and includes at least one high temperature mode and at least one low temperature mode.

2. The trap of claim 1, where said body comprises a fiberglass mesh.

3. The trap of claim 1, wherein said body comprises a polytetrafluoroethylene (PTFE) coating.

4. The trap of claim 1, wherein said feature comprises an opaque portion in said body, said opaque portion configured to block a first transmission of light through said body.

5. The trap of claim 4, wherein said feature comprises a void in said body, said void configured to enable a second transmission of light to pass through said body.

6. The trap of claim 14, wherein said feature comprises one or more filters configured to detectably modify light passing through said body.

7. The trap of claim 1, wherein said feature comprises a two-dimensional bar code associated with the one of the plurality of analysis modes, said bar code being printed on the trap.

8. The trap of claim 1, wherein said body comprises a material configured to enable vaporization of the sample at temperatures of at least 300 degrees Celsius, wherein the desorber is configured to heat said body to a temperature of at least 300 degrees Celsius according to a first analysis mode of the plurality of analysis modes, and wherein the desorber is configured to heat said body to a temperature below 300 degrees Celsius according to a second analysis mode of the plurality of analysis modes.

9. A desorber assembly for an analysis device, comprising:
an inlet configured to receive a trap having, on a first region thereof, a sample of a substance of interest for analysis, the analysis selected from a plurality of analysis modes, and a detectable feature located in a second region of the trap, wherein the detectable feature is associated with one of the plurality of analysis modes;
a sensor subsystem configured to detect the detectable feature upon insertion of the trap into said inlet; and
a heating subsystem configured to heat the sample according to the one of the plurality of analysis modes upon detecting the detectable feature and based upon the detectable feature, wherein the plurality of analysis modes includes at least one high temperature mode and at least one low temperature mode.

10. The desorber assembly of claim 9, wherein said sensor subsystem comprises:
a light source configured to generate a transmission of light; and
a light sensor configured to:
detect the transmission of light when it passes through the detectable feature of the trap, and
detect a blocking of the transmission of light when it is blocked by the detectable feature of the trap.

11. The desorber assembly of claim 10, wherein said sensor subsystem comprises a plurality of light sensors respectively configured to:
detect the transmission of light when it passes through the detectable feature of the trap at a plurality of locations in the second region, and
detect a blocking of the transmission of light when it is blocked by the detectable feature of the trap.

12. The desorber assembly of claim 11, wherein detection of the transmission of light by a subset of said plurality of light sensors is associated with a first analysis mode of the plurality of analysis modes.

13. The desorber assembly of claim 12, wherein detection of the transmission of light by a different subset of said plurality of light sensors is associated with a second analysis mode of the plurality of analysis modes.

14. The desorber assembly of claim 11, wherein said plurality of light sensors is located bilaterally symmetric with relative to a centerline of said desorber such that the detectable features of the trap are detected upon insertion of the trap into said inlet in at least two different orientations.

16. The desorber assembly of claim 11, wherein said plurality of light sensors are respectively configured to selectively detect the transmission of light and the blocking of the transmission of light.

17. The desorber assembly of claim 10, wherein said light source comprises at least one of a light emitting diode (LED), fluorescent lamp, an incandescent lamp, and a light amplification by stimulated emission of radiation (LASER) configured to direct a beam of light toward the trap.

18. The desorber assembly of claim 10, wherein said light sensor comprises at least one of a photodiode, a phototransistor, a photoresistor, and a wavelength specific receiver.

19. (canceled)

20. (canceled)

21. (canceled)

22. (canceled)

23. (canceled)

24. (canceled)

25. (canceled)

26. (canceled)

27. (canceled)
